(19) United States
(12) Patent Application Publication
(10) Pub. No.: US 2019/0121602 A1
(43) Pub. Date: Apr. 25, 2019

(54) USER INTERFACE FOR THE REMOTE CONTROL OF A MECHANICAL MUSIC MACHINE

(71) Applicant: David Ray Burritt, Broomfield, CO (US)

(72) Inventor: David Ray Burritt, Broomfield, CO (US)

(21) Appl. No.: 16/112,488

(22) Filed: Aug. 24, 2018

Related U.S. Application Data
(60) Provisional application No. 62/574,602, filed on Oct. 19, 2017.

(51) Int. Cl. G06F 3/16; G06F 8/20; G06F 8/38; G06F 8/65

(52) U.S. Cl. CPC G06F 3/165; G06F 8/65; G06F 8/38; G06F 8/20

(57) ABSTRACT

A way to design a user interface designed to control one or more mechanical music machines from one or more computing devices. The user interface is designed in a manner so that no custom application(s) is required on the user's computing device. Therefore, no changes will be necessary if an operating system update is released for the one or more computing devices the user(s) are using to control the mechanical music machine(s).

### BACKGROUND

Many mechanical music machines have been converted to play music using MIDI systems instead of what they were designed to use when they were built. Those original systems were typically paper rolls with holes in them or paper/cardboard panels with holes in them. The modern MIDI systems replace the rolls or panels with an electronic system that typically connects to the hardware which read the rolls/panels. This electronic system emulates the signaling to the mechanical music machine that the rolls/panels would send.

The data which is sent to the MIDI system is typically stored in a file on a computing device, typically a laptop computer. A user typically selects the song he/she want to play by tapping on it and the computer then transmits the data from the computing device to the Midi system and the Midi system in turn sends it to the mechanical music machine. The method of transmission from the computing device can be either wireless (e.g., wifi/Bluetooth), wired ethernet connections or a proprietary wireless/wired design. The computing device and the MIDI system could also be contained in the same hardware component.

The problem that all the existing solutions have is that when the manufacturer of the operating system (e.g., Microsoft Windows, Google Android, Apple IOS) comes out with an update to the operating system the program which was being used may no longer work. This will result in the user having to wait for a new application to be written or to be updated. Writing and updating an application is costly in both terms of time and money. For example, Apple released an update to its IOS operating system which runs on all Apple iPhones and iPads. This operating system requires the applications which run on it to be 64 bit applications. All applications which were written prior to that release of the operating system and were not 64 bit applications would need to be either re-written or re-compiled and then distributed to the devices.

This invention shows a way that an existing MIDI system can be modified or a new MIDI system built which will remove the requirement for having to update the application which presents the user experience for controlling which songs are sent to the mechanical music machine.

### BRIEF SUMMARY OF THE INVENTION

A method showing how the user interface for a MIDI system which controls mechanical music can be designed so future updates to the user interface are no longer required when an operating system update is performed.

### BRIEF DESCRIPTION OF THE DRAWINGS

FIG. 1: Represents a typical mechanical music machine. Mechanical music machines come in a wide variety of shapes and sizes.

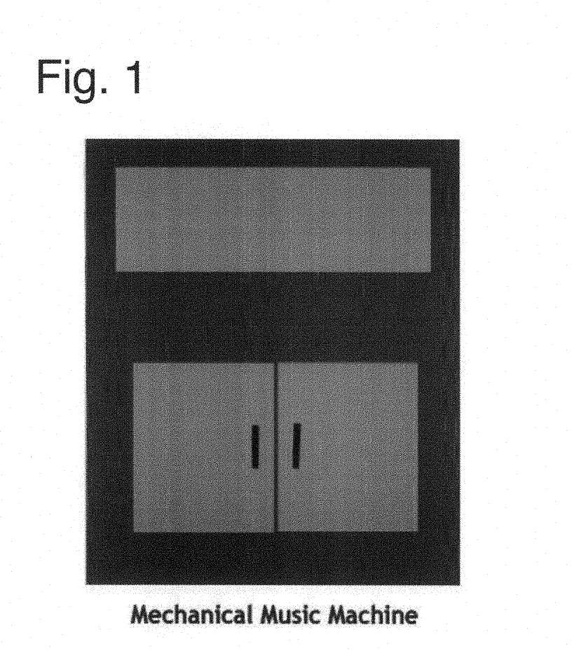

FIG. 2: Represents a typical MIDI system which interfaces to the mechanical music machine. A MIDI feed comes into the hardware and the hardware converts that to control signals that the mechanical music machine understands.

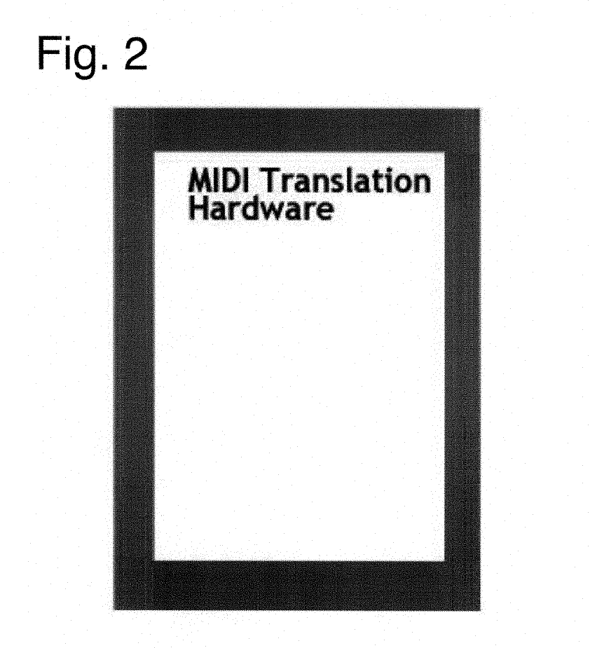

FIG. 3: Represents a typical laptop style computing device

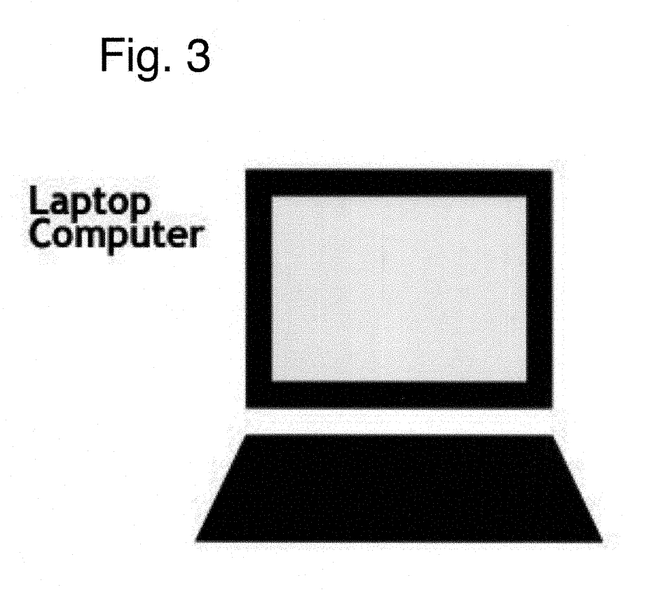

FIG. 4: Represents a typical computing device running a web server

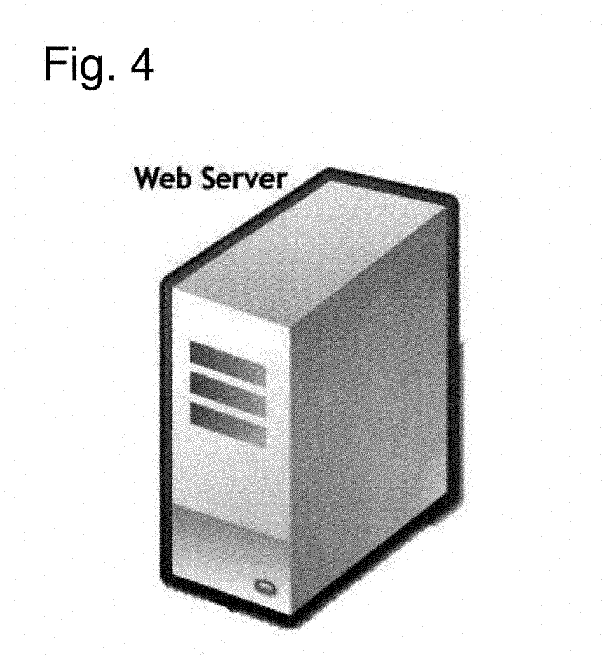

FIG. 5: Represents a typical mobile computing device, typically a smart phone or a tablet computing device.

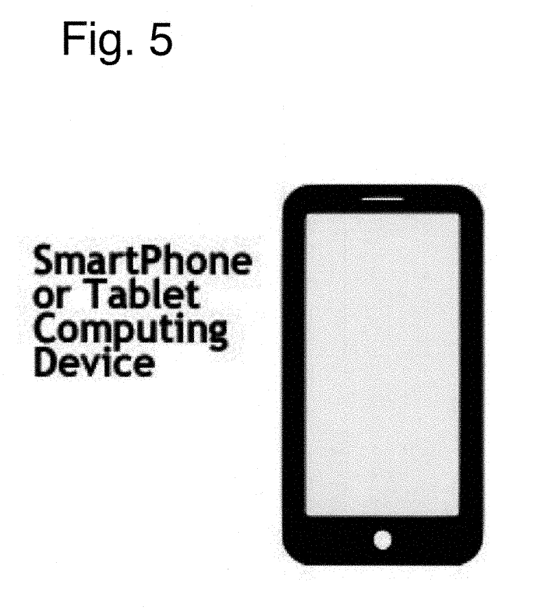

FIG. 6: Represents a picture of how the hardware could be connected as described in [0013].

FIG. 7: Represents a picture of how the hardware could be connected as described in [0014].

FIG. 8: Represents a picture of how the hardware could be connected as described in [0015].

FIG. 9: Represents a picture of how the hardware could be connected as described in [0016].

FIG. 10: Represents a picture of how the hardware could be connected as described in [0017].

FIG. 11: Represents a picture of how the hardware could be connected as described in [0018].

FIG. 12: Represents a picture of how the hardware could be connected as described in [0019].

FIG. 13: Represents a picture of how the hardware could be connected as described in [0020].

### DETAILED DESCRIPTION OF THE INVENTION

In a typical configuration a user is using a remote computer which has direct access to the MIDI files via its file system. The remote computer is communicating to the MIDI board which is connected to the mechanical music machine. The laptop computer is running a well known operating system (e.g., Microsoft Windows, Apple IOS, Google Android, Linux, etc.) and this operating system gets updated periodically by the entity that is responsible for it.

The method of how the remote computer communicates to the MIDI system is irrelevant. It could be via wifi, Bluetooth, wired ethernet, or any other means.

The operator of the remote computer wishes to play a song on the mechanical music machine. To do so, he/she runs an application that was specifically designed to run on the remote computer. For example, if the remote computer is a laptop running the Windows operating system the user may run a program that was written in Visual Basic or .NET or any other language that is supported by the operating system.

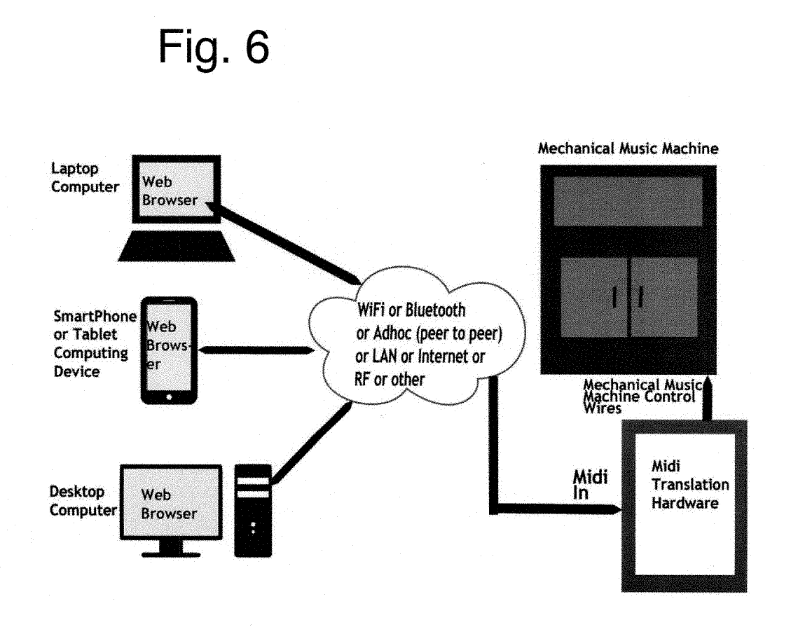

The application will present a user interface to the operator which will allow him/her to select a song (or songs) to be played on the mechanical music machine. Once the user interface determines the music should be sent to the mechanical music machine (e.g., the user hits a “play” button on the user interface) the application will either send the data to the MIDI hardware directly or instruct another entity (e.g., another application) to do it. The application may open and send the MIDI file directly or perhaps ask a helper application to do this (e.g., Windows Media Player). The actual mechanism of getting the MIDI data from the computing device to the Midi Transition Hardware can be via any means (e.g., wifi, bluetooth, peer to peer networking, hardwired, etc.) See FIG. 6.

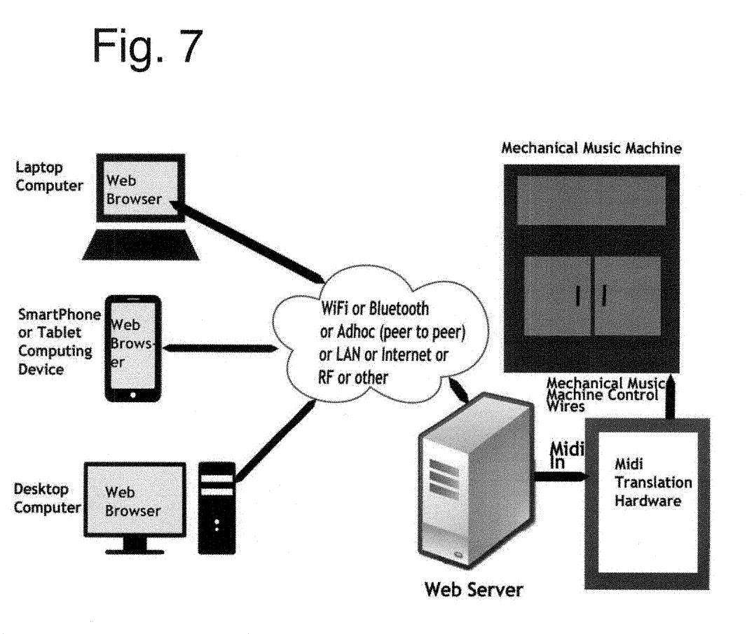

In one embodiment of the invention the applications that are referred to in [0013] are replaced by using a web browser that is supplied with the operating system (e.g., Microsoft Explorer, Apple Safari, Google Chrome). A computer running a web server is connected to the MIDI translation hardware which is connected to the mechanical music machine. The computer running the web server has access to the MIDI files on its server and also supports server side scripting (e.g., PHP). The web server also has web pages designed to present the user interlace to the user and existing client side web page processing will allow the web server to present a user interface. Web pages, by design, will work with any modern operating system and web pages do not need to be updated when a new version of an operating system is released. In addition, the browser applications are supplied by the vendor of the operating system and therefore do not need to be updated when an operating system is updated. See FIG. 7.

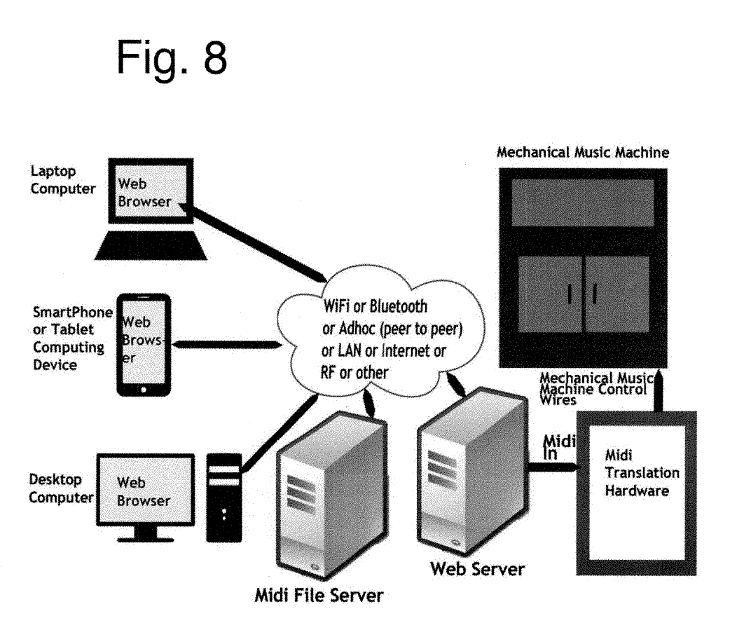

In another embodiment of the invention, the MIDI files are not stored on the web server but on another computing platform the web server has communication access to. For example, there might be a server in the cloud which contains a library of MIDI files and one or more of those files can be downloaded to the web server and then sent to the MIDI control board. See FIG. 8.

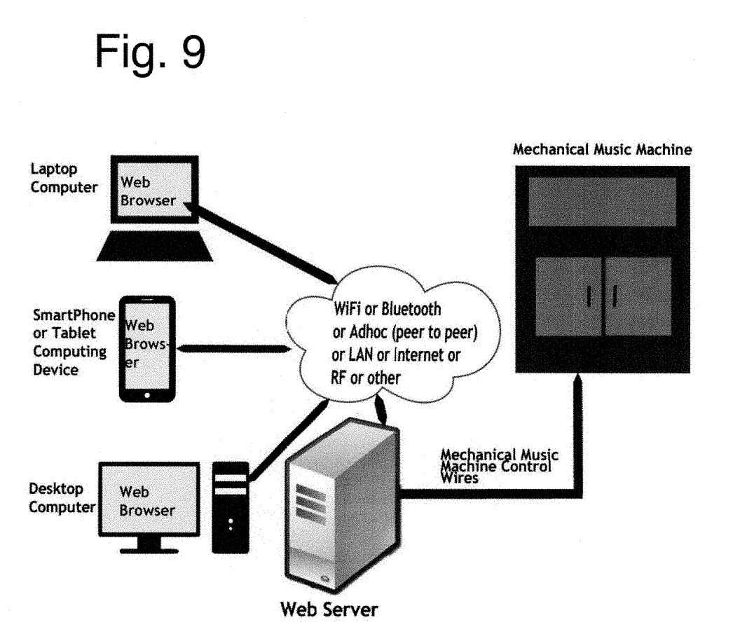

In another embodiment of the invention the web server and the MIDI board are combined into a single computing platform. See FIG. 9.

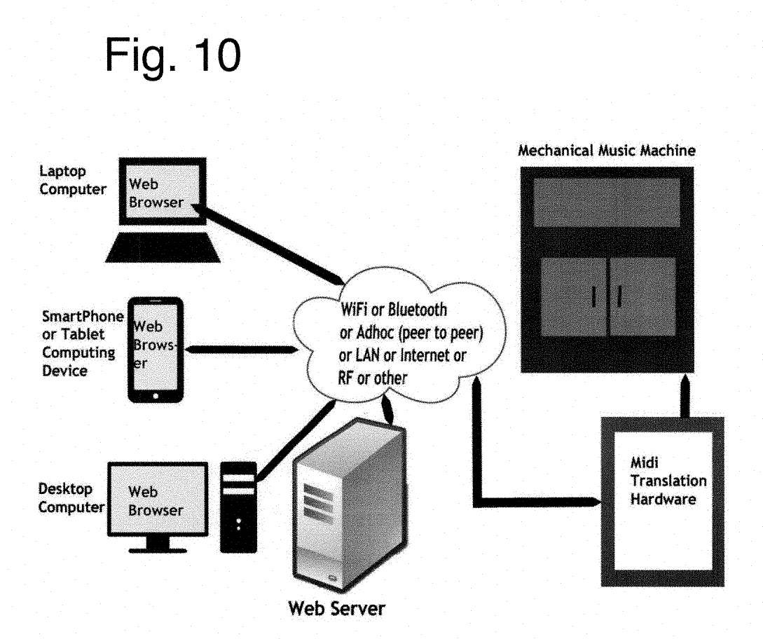

In another embodiment of the invention the web server is not in the physical vicinity of the MIDI system but rather in the cloud. The web server is able to communicate to the MIDI system via the Internet. See FIG. 10.

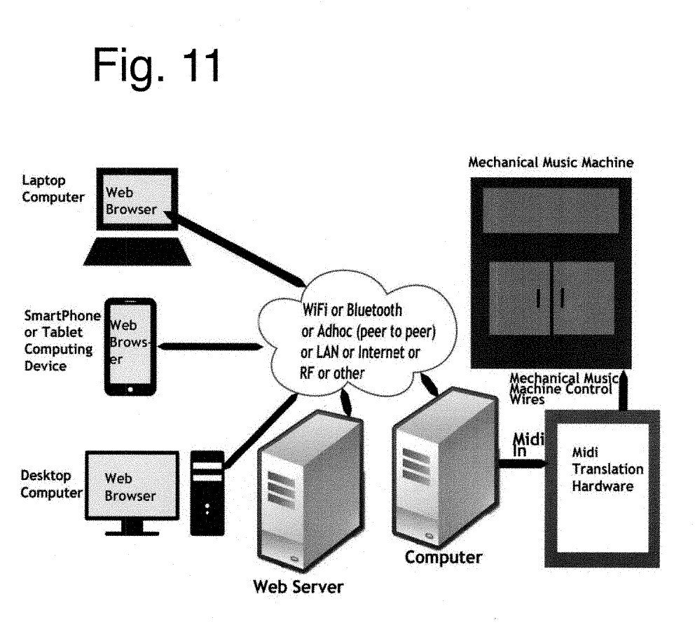

In another embodiment of the invention there is a computer connected to the Midi Translation hardware and also connected to the cloud. The computer will have a program that has one or more Internet socket connections which communicate directly to the browser running on the users endpoint (e.g. smartphone/laptop/desktop). In this embodiment the web server's only purpose is to deliver the original web page to the user's computer. It does not facilitate in the communication between the browser and the computer connected to the Midi translation hardware. See FIG. 11.

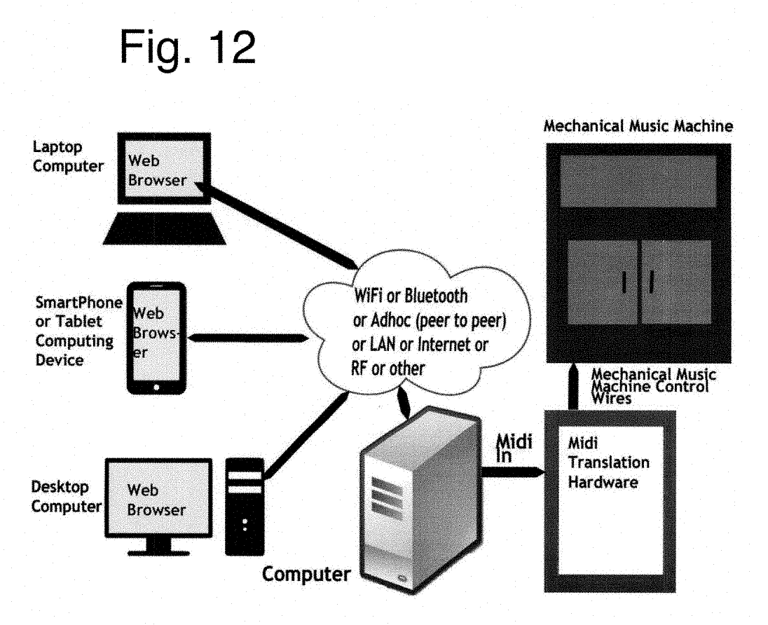

In another embodiment of the invention no web server is required. The web page the user goes to could be stored locally on the users device (i.e., laptop, smartphone, desktop PC) or available on a network connected folder. In this embodiment the browser would have a socket connection directly to the computer which is connected to the Midi Translation Hardware. See FIG. 12.

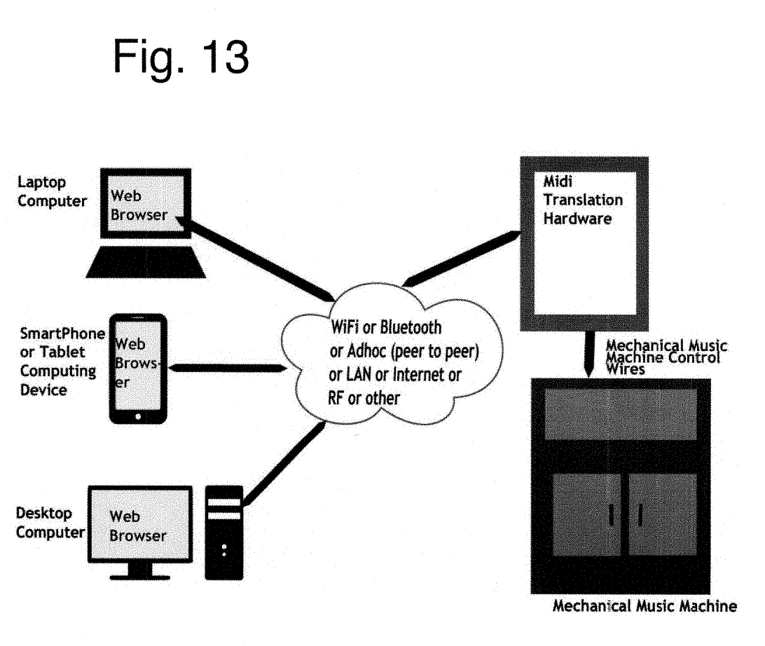

In another embodiment of the invention the Midi Translation Hardware has the capability of communication to the user's endpoint (i.e., smartphone, laptop, desktop PC) so no additional computer is required. The midi files that will be played could be on the Midi Translation Hardware or downloaded via the cloud from a remote location. See FIG. 13.

It should be noted that in all embodiments of the invention there is no custom software running on the computing devices which are accessed directly by the user. That is, no customer software is running on the laptop computer, the smartphone or tablet computer of the desktop computer. The only software required is a web browser which is supplied by the manufacturer of the computing device.

It should be noted that the MIDI protocol is being used as a convenience. If a different protocol is used for transmitting the music that is to be played then that will not affect the invention or the claims because the invention is around the user interface.

It should be noted that the embodiments shown in this application assume the web browser is being supplied by the company who provided the operating system or hardware for the user's computing platform. However, the user could be using any modern browser. For example, a user might want to use Chrome (by Google) on an Apple iPhone and that would also work.

1. A way to design a human interface for controlling a mechanical music machine without having a custom written application residing on the user's computing device.

2. A way to design a human interface for controlling two or more mechanical music machines without having a custom written application residing on the user's computing device.

3. A way to control a mechanical music machines on multiple computing devices simultaneously without having a custom computer application running on those computing devices.
